(19) United States
(12) Patent Application Publication
(10) Pub. No.: US 2014/0013498 A1
(43) Pub. Date: Jan. 16, 2014

(54) Aircraft Lavatory Urinal

(71) Applicant: Mag Aerospace Industries, Inc., Carson, CA (US)

(72) Inventors: Razmik B. Boodaghians, Glendale, CA (US); Kevin Huang, Los Angeles, CA (US); Christoph Goeschel, Seattle, WA (US); Christina Ortolan, Long Beach, CA (US); Vikram Chauhan, Redondo Beach, CA (US)

(21) Appl. No.: 13/942,919

(22) Filed: Jul. 16, 2013

Related U.S. Application Data
(60) Provisional application No. 61/671,905, filed on Jul. 16, 2012.
(60) Provisional application No. 61/833,497, filed on Jun. 11, 2013.

(51) Int. Cl. B64D 11/02

(52) U.S. Cl. CPC B64D 11/02
USPC 4/301; 4/144.1

(57) ABSTRACT

Embodiments of the present invention provide integration of aircraft urinals into vacuum waste systems of commercial aircraft. The urinals may either be rinse versions or waterless urinals.

### CROSS REFERENCE TO RELATED APPLICATIONS

This application claims the benefit of U.S. Provisional Application Ser. No. 61/671,905, filed Jul. 16, 2012, titled “Waterless Urinal for Aircraft Lavatory,” and U.S. Provisional Application Ser. No. 61/833,497, filed Jun. 11, 2013, titled “Urinal Valve Improvements,” the entire contents of each of which are hereby incorporated by reference.

### FIELD OF THE INVENTION

Embodiments of the present invention relate generally to integration of aircraft urinals into vacuum waste systems of commercial aircraft. The urinals may either be rinse versions or waterless urinals.

### BACKGROUND

The current space requirement for a comfortable lavatory with sink, amenities station, and traditional seated toilet consumes real estate valuable to airlines seeking to maximize passenger seating. There is significant value in reducing floor space dedicated to lavatories without reducing relief service to the passengers and crew. The present inventors have determined that by replacing a single traditional lavatory complex with a urinal stall, valuable floor space can be freed for paying customer seating. Although it is recognized that a dedicated urinal will serve only a portion of passenger waste elimination demand, it will also greatly ease demand on existing lavatories. The demand is expected to ultimately balance, and not encumber, passengers seeking a traditional lavatory.

The flushing of toilets on a typical aircraft is estimated to consume about 25% of the potable water demand. For example, on a 10 hour mission for a B777, this amounts to about 77 gallons of water, which adds a substantial weight to the aircraft. It is estimated that about 50% of this demand is from male passengers, of which a further 50%-66% can be estimated as flush water for liquid waste. Thus, it is estimated that about 33% of lavatory uses are for male elimination of liquid waste, amounting to 20-25 gallons of flush water, for which a dedicated urinal would be useful, and possibly, even eliminate this water usage.

Additionally, a single lavatory use has been averaged to be about 6 minutes, limiting the lavatory to about 10 uses in an hour. In the hours following an in-flight meal service, this can create significant usage delays for passengers. Using previous estimates, if 33% of these lavatory uses are for male elimination of liquid waste, male passengers served by a dedicated liquid waste lavatory will reduce demand on existing traditional lavatory installations, alleviating traffic and allowing additional time for female or other lavatory uses.

The space requirement for a comfortable traditional lavatory also takes up valuable real estate for passenger seating, which means less revenue for the airline. Providing a smaller footprint for a urinal-only lavatory can help increase airline revenues by providing more seating for paying passengers.

### BRIEF SUMMARY

Embodiments of the invention described herein thus provide urinal-only lavatory space, as well as integration of aircraft urinals into vacuum waste systems of commercial aircraft. The urinals may either be rinse versions or waterless urinals.

### BRIEF DESCRIPTION OF THE DRAWINGS

FIG. 1 shows a top plan view of a urinal system for use in an aircraft lavatory.

FIG. 2 shows a front perspective view of one embodiment of an aircraft lavatory urinal.

FIG. 3 shows a side plan view of one embodiment of a flush system for a urinal.

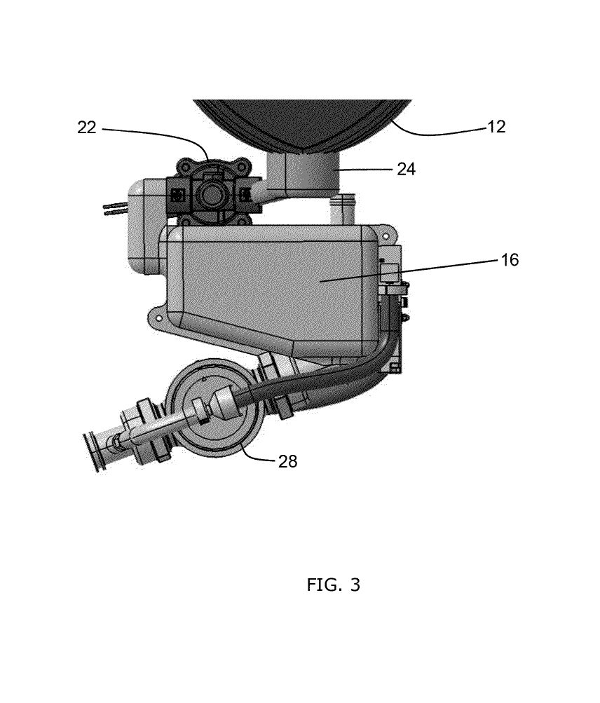

FIG. 4 shows a side perspective view of a flush system having a varying shaped reservoir.

FIG. 5 shows a back perspective view of a urinal with an improved flush system.

### DETAILED DESCRIPTION

Embodiments of the present invention provide alternate versions of urinal-only lavatories for use on-board passenger transport vehicles, such as aircraft. A waterless version and a rinse version are provided. For both options, the urinal 10 consists of a typically shaped bowl 12 or funnel, similar to existing consumer urinals but that may be coated with a low-friction or hydrophobic surface, and a collection basin 16 with an interface or isolation valve 22 between the urinal assembly 10 and the vacuum waste system. For the waterless embodiment, there is also provided a barrier-cartridge 14 with a technology to provide odor capture while allowing a gravity-powered path for urine, as no potable water is used to rinse or flush the urinal. Urine will be directed downward toward the barrier cartridge 14 through a combination of gravity, the shaped bowl 12, and a low-friction or hydrophobic surface coating. The surface coating may be Teflon or other non-stick coating designed to minimize droplet collection and to encourage gravity-driven flow to the bottom of the urinal bowl. A grilled drain may be provided at the base of the bowl to allow urine to exit the bowl.

For the waterless embodiment, the barrier cartridge 14 provides an odor capture technology suitable for aircraft safety and maintenance requirements. This can include but is not limited to: oil-based liquid barriers, elastomeric valve seals, and any other appropriate odor capture technology that is presently available or designed to be available in the future. The fully integrated urinal assembly accepts liquid waste material and transfers the waste to the waste system through an interface valve 22 that is similar in function to the Monogram Systems Grey Water Interface Valve, which coordinates the transfer of waste in the waste lines to a remote waste holding tank for later disposal. One advantage of the current urinal system is that it prevents an open air connection between the lavatory surroundings and the waste system via use of the one-way barrier cartridge and the interface valve.

In one embodiment, the cartridge 14 is a one-way cartridge that allows liquid to pass through periodically while providing a continuous seal against escaping odorous gasses from the waste system. Examples include an oil-trap or a deformable skirt technology, combined with a periodic bowl rinse based on volumetric control or a time-based control. In another embodiment, the cartridge may provide a semi-permeable gate to allow liquid waste through, while also maintaining separation between the lavatory atmosphere and the waste system. Some examples of such gates are provided by Waterless Co.'s Ecotrap (in which an oil-based liquid prevents odor from returning to the lavatory), elastomeric membranes provided by Duravit Waterless Urinal (which is a flexible polymer hose that closes on an outlet end when there is no liquid flow) or by LiquidBreaker with Green Cartridge (which is a silicone skirt that allows liquid flow and blocks odor passage). However, the present inventors desired to use the vacuum system to create the urinal flush, and exposure of these systems to vacuum could cause their degradation much more quickly in the aircraft environment or could void the liquid sealants' effectiveness. Accordingly, by providing a vacuum system interface valve 22 designed to withstand and work under vacuum pressure, but to seal the barrier cartridge from the vacuum when applied for the flush, the exposure of the cartridge to the vacuum is eliminated.

Once urine and/or flush water exits the drain, a new flush system is provided for controlling the further flow of the fluid. In the waterless version, an interface valve 22 assists the system in that it provides a periodic flush of the collection basin 16, but no flush water is needed for each use. Urine passes directly through the drain, through the one-way cartridge, through the valve described below, and into the reservoir 16. In the rinse embodiment, there is a reduced volume of rinse fluid needed, and the urine and rinse water pass through the drain, through the valve described below, and into the reservoir 16. Once the reservoir is full, the interface valve system is activated to transfer liquid in the collection basin 16 to the main waste tank 20.

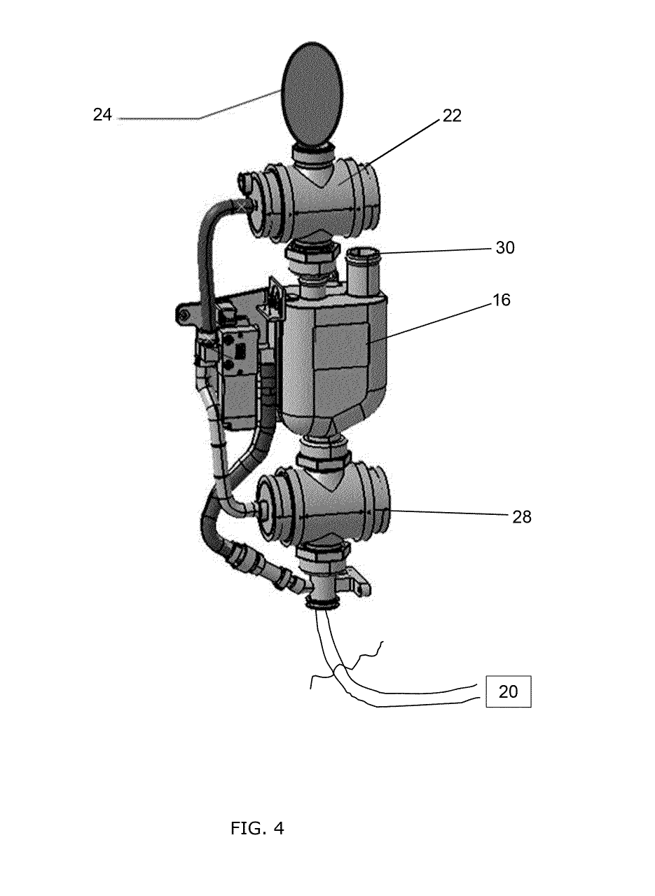

More specifically, the new flush valve system for urinals described herein may be used for a waterless urinal or for a traditional urinal on board the aircraft. It allows for a periodic flush of liquid collected in a reservoir below the urinal, preventing the need for a full vacuum flush upon every urinal use. As discussed, one of the important features of a urinal is water and space savings. These issues are particularly important on-board aircraft and other passenger transport vehicles, where space and weight savings are of extreme importance. As shown in FIG. 4, below the urinal drain is a first valve 22, which may be a reverse pinch valve, a solenoid valve, or any other appropriate valve. This valve 22 functions in a typically open configuration and connects the urinal basin 12 to a holding tank/reservoir/collection basin 16. Valve 22 generally acts as an interface valve between the urinal liquid and the reservoir 16 and fluidly connects the two elements. If the first valve 22 is provided as a reverse pinch valve, then it is held in an open position and allows liquid to flow directly into the holding tank/reservoir. If the first valve 22 is a solenoid valve, it will remain in open position to transfer liquid into the holding tank/reservoir. (For the waterless urinal embodiment, a cartridge can be installed in urinal drain to prevent odors, as described above. Eclean (or a similar solution) may be used to rinse and aide with odor prevention/disinfection in case of a flush-type urinal.)

Regardless of the type of first valve 22 provided, once the liquid transfer is to begin, the valve 22 functions to move liquid from the urinal bowl 12 to the holding tank/reservoir/collection basin 16. Basin reservoir 16 can hold liquid until it is full and is emptied all at once. This can assist with reduced power and reduced noise, as the vacuum flush sounds can be quite loud, even outside the lavatory.

The liquid waste flows via a urinal drain 24 into the reservoir basin 16. A level sensing function may be provided by a sensor or level sensing device 26 that can be a captured air-column pressure sensor or a capacitive level sensor, or any other appropriate sensor. There may be a logic system provided in the urinal controller such that when liquid reservoir reaches a predefined point, a flush request is initiated. (It should be understood that a manual override switch may also be provided for an on-demand flush, if desired.) Once a sensor or level sensing device 26 reports that the reservoir basin 16 is full by generating a “tank full” signal, the first valve 22 (which may be a solenoid valve, a pinch valve, a reserve pinch valve, or any appropriate valve) will close and a lower valve 28 (below the reservoir basin) opens up and exposes the contents of the basin to the vacuum. Air rushes in through a vent port 30. The pressure differential drives the valve action. Closure of the upper valve 22 and opening of the lower valve 28 transfers the liquid in the reservoir basin 16 to the main waste tank 20 on-board the vehicle. The air sucked in through the vent port 30 allows the flush to proceed. When the lower valve 28 opens, the upper valve 22 closes, creating vacuum and preventing a loud suction sound for the flush.

A flush request closes the isolating-valve above the liquid reservoir and seals the one-way cartridge from the vacuum system. The system then opens a control solenoid 18 in the interface valve assembly, which exposes the pinch tube to vacuum. The pinch tube opens, and the opened pinch tube exposes differential pressure of vacuum waste system to flush liquid reservoir. Liquid rushes out of reservoir driven by gravity and differential pressure. A level sensor detects falling liquid level and sends signal at predefined point to close control solenoid.

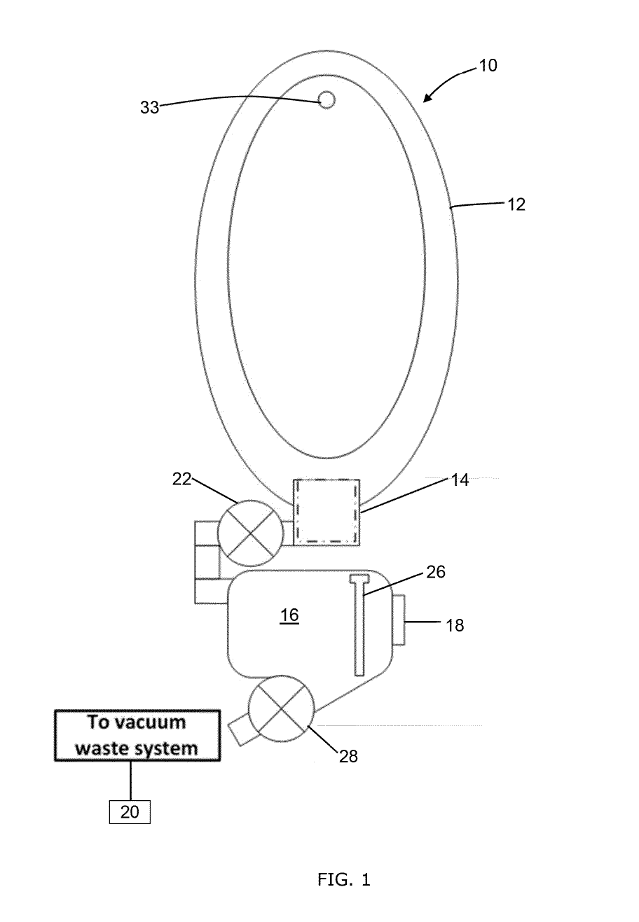

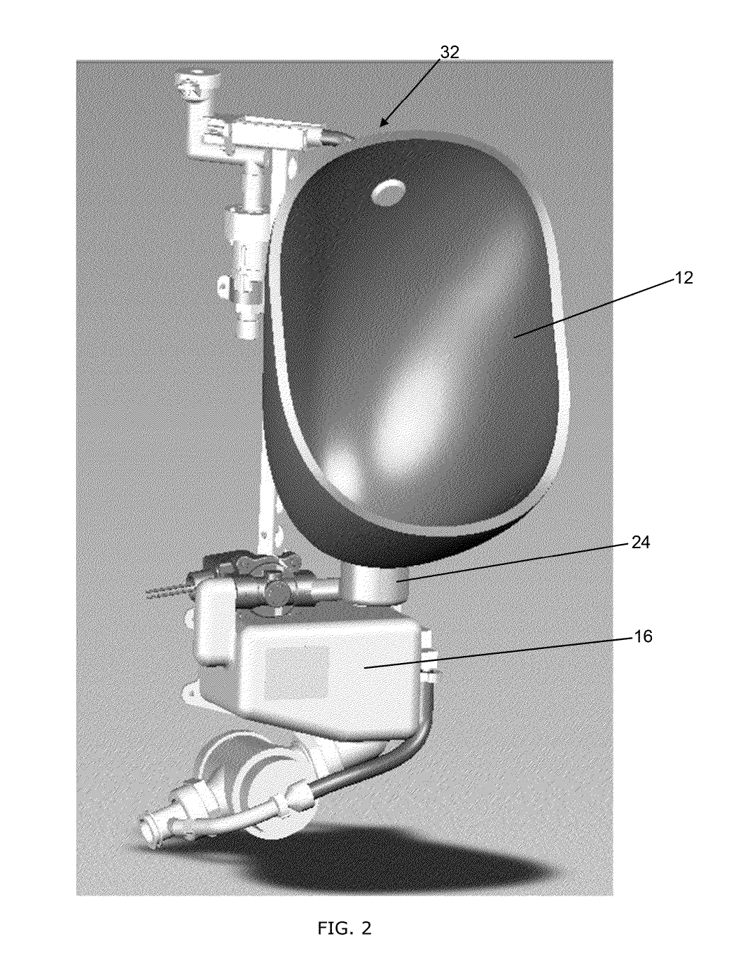

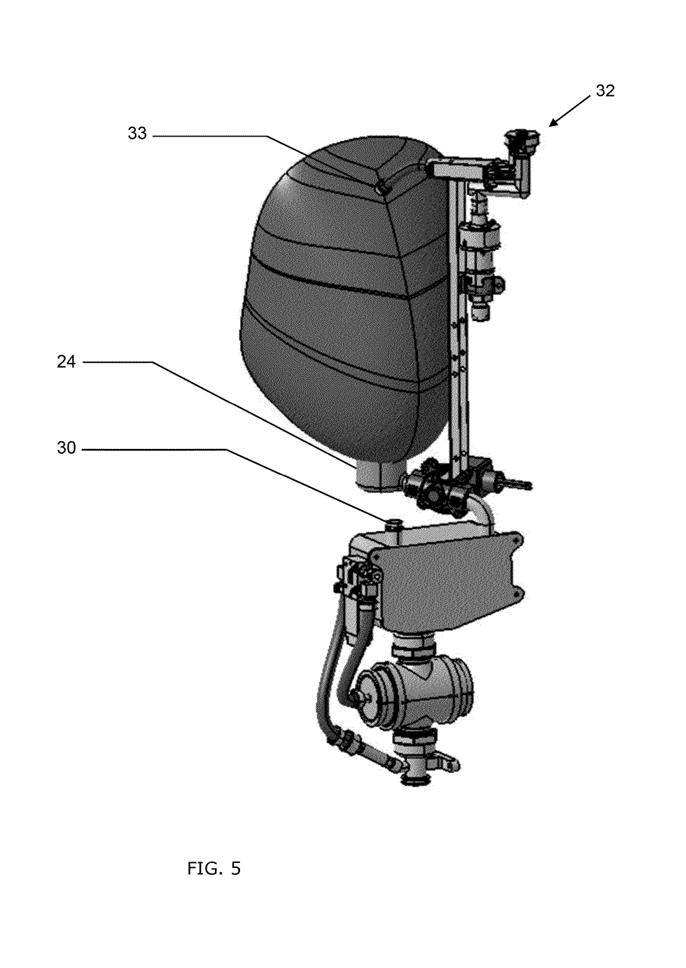

FIGS. 1, 2, and 5 show an alternate embodiment with a rinse assembly 32 and nozzle 33, which may be used for flushing urinals that are not designed to be waterless. Obviously, the rinse assembly is not necessary for the waterless version. The dual valve 22, 28 and holding tank/reservoir/collection basin 16 concept is valid for both versions: waterless and water-using.

By integrating the urinal with the vacuum waste systems, a better and more efficient flush can be achieved. In the rinse version, a periodic introduction of collected liquid into the waste system reduces water consumption. The urinal need not flush with every use because a localized reservoir collect urines and/or flush water until there is sufficient liquid in the reservoir that requires a need for flushing. The waterless flush technologies that are currently available are incompatible with vacuum waste systems, without the modifications to the flush system described herein. Rapid air movement through the waterless cartridge reduces internal sealant measures and product lifetime to the point of ineffectiveness. The solution for this is to include an isolating-valve upstream of the reservoir to seal the cartridge from vacuum exposure. This normally-open isolating-valve will close when a reservoir flush is initiated by a “full” signal from the level sensor or a manually actuated flush, while the check-gated atmospheric vent is to provide air inlet for flush.

Changes and modifications, additions and deletions may be made to the structures and methods recited above and shown in the drawings without departing from the scope or spirit of the invention and the following claims.

What is claimed is:

1. A urinal for use on-board an aircraft, comprising:
(a) a basin for collecting human liquid waste;
(b) an upper valve configured to open and close as desired in order to deliver the liquid to a collection reservoir;
(c) a collection reservoir for holding the liquid until a vacuum flush of the reservoir is activated; and
(d) a lower valve in fluid communication with an aircraft main waste tank, wherein when a vacuum flush of the reservoir is activated, the upper valve closes and the lower valve opens, delivering the liquid to the aircraft main waste tank.

2. The urinal of claim 1, wherein the urinal uses a water rinse and comprises a rinse assembly.

3. The urinal of claim 1, wherein the urinal is a waterless urinal.

4. The urinal of claim 3, wherein the waterless urinal further comprises a barrier cartridge for odor elimination.

5. The urinal of claim 1, further comprising a level sensing device.

6. The urinal of claim 1, wherein the upper valve comprises a reverse pinch valve.

7. A method for saving space on-board an aircraft, comprising:
(a) providing a urinal-only lavatory, the urinal in the urinal-only lavatory comprising:
(i) a basin for collecting human liquid waste;
(ii) an upper valve configured to open and close as desired in order to deliver the liquid to a collection reservoir;
(iii) a collection reservoir for holding the liquid until a vacuum flush of the reservoir is activated; and
(iv) a lower valve in fluid communication with an aircraft main waste tank,
(b) wherein when a vacuum flush of the reservoir is activated, the upper valve closes and the lower valve opens, delivering the liquid to an aircraft main waste tank.
